(19) United States
(12) Patent Application Publication
(10) Pub. No.: US 2025/0136207 A1
(43) Pub. Date: May 1, 2025

(54) JOINT STRUCTURE OF VEHICLE BODY

(71) Applicants: Hyundai Motor Company, Seoul (KR); Kia Corporation, Seoul (KR)

(72) Inventor: Jonghoon Lee, Hwaseong-si (KR)

(21) Appl. No.: 18/800,865

(22) Filed: Aug. 12, 2024

(30) Foreign Application Priority Data
Oct. 31, 2023 (KR) 10-2023-0147708

(51) Int. Cl. B62D 63/02

(52) U.S. Cl. CPC B62D 63/025

(57) ABSTRACT

An embodiment joint structure of a vehicle body includes a driving module detachably mountable on a front part of an underbody of a vehicle and a space module detachably mountable on the underbody, wherein the space module is selected from a plurality of differently shaped space modules, is joinable to the underbody, is capable of being moved independently, is joinable to the driving module to be movable in a group with the driving module, and is interchangable with other space modules of the plurality of differently shaped space modules selectable based on a shape and a purpose of the space module.

### CROSS-REFERENCE TO RELATED APPLICATIONS

This application claims the benefit of Korean Patent Application No. 10-2023-0147708, filed on Oct. 31, 2023, which application is hereby incorporated herein by reference.

### TECHNICAL FIELD

The disclosure relates to a joint structure of a vehicle body.

### BACKGROUND

An automobile industry has been recently introducing a new concept of a future mobility vision to realize a human-centered dynamic future city. One of these future mobility solutions may be a purpose built vehicle (PBV) which is a purpose-based mobility vehicle.

An example of the PBV may be an eco-friendly mobile vehicle based on an electric vehicle (EV). This PBV may provide various customized services to a user during a transport time from its origin to destination through an unmanned or manned autonomous traveling manner.

A vehicle body of the PBV may include an underbody (also referred to as a chassis frame, a rolling chassis, or a skateboard in the industry) and an upper body assembled to the underbody.

Here, the upper body may have various forms based on a type of the customized service for the PBV. For example, the PBV may be used as a hailing-type vehicle having cabins disposed at the front and rear parts of the upper body. Further, the PBV may be used as a cab-type vehicle having the cabin disposed only at the front part of the upper body. Furthermore, the PBV may be used as a delivery-type vehicle having the cabin (or a driving module) at the front part of the upper body and a luggage room (or a space module) at the rear part.

According to this conventional technology, a cost of changing a structure of the upper body may be increased based on the various customized services for the PBV as described above. Therefore, there is a need to develop a joint structure of the vehicle body that may be changed into various types of vehicle bodies based on the type of customized service for the PBV.

### SUMMARY

The disclosure relates to a joint structure of a vehicle body. Particular embodiments relate to a joint structure of a vehicle body that may include a driving module and a space module in a purpose built vehicle (PBV).

Embodiments of the disclosure provide a joint structure of a vehicle body of a vehicle in which the driving module and space module of a vehicle upper body may be detachable, the space module may be utilized and recycled as a separable structure for various purposes, and the driving module may be separable during vehicle travel.

According to an embodiment, provided is a joint structure of a vehicle body, the structure including a driving module detachable from a front part of an underbody of a vehicle and a space module having various shapes and detachable on the underbody, wherein the space module is joined to the underbody, is capable of being moved independently, is joined to and communicated/cooperated with the driving module to thus be moved in a group, and is capable of being changed and replaced based on the shape and purpose of the space module.

The underbody may be mounted with at least one detachable battery storing energy consumed by the space module.

The space module may be mounted with a detachable controller which controls a device installed at the underbody, the driving module, or the space module and performs calculation for the device.

The space module may be mounted with a detachable integrated thermal management device disposed outside the space module and capable of performing cooling, heating, and air-conditioning in the space module or cooling a device in the space module.

The space module may be mounted with a camera functioning as a closed-circuit television (CCTV) and an autonomous traveling device, a space lighting device functioning as an external light and a flashing light, and a solar roof functioning to convert light energy to electrical energy.

The structure may further include a detachable dolly integration module disposed at the front part of the underbody and driven by an in-wheel motor to move the space module while the space module is mounted on the underbody.

The dolly integration module may include a dolly autonomous traveling electronic device enabling low-speed autonomous traveling and driving.

The structure may further include a rear wheel suspension device disposed at a rear part of the underbody or the rear of the driving module and enabling the space module to be moved.

The driving module may include a driving autonomous traveling device and a driving lighting device that enable the autonomous traveling and driving of the driving module.

The space module may be installed with an external airbag for absorbing an impact occurring when the driving module and the space module collide with each other.

In the space module, an additional space module may be connected to a side part of the space module by using a lateral connection structure.

The rear wheel suspension device and the dolly integration module may be sequentially joined to the rear of the driving module.

A driving module sensor may be disposed at a rear part of the driving module, a space module sensor may be disposed at a front part of the space module, and distance and angle signals between the driving module and the space module may be measured by mutual detection of the driving module sensor and the space module sensor to be transmitted to a sensor control unit.

The sensor control unit may control a motor and a wheel, disposed at the driving module, by the measured distance and angle signals.

An additional space module may be further disposed at a rear end of the space module, the additional space module may be installed with an additional dolly integration module and the rear wheel suspension device, and the space module may be moved by installing a rear connection structure between the space module and the additional space module and on an upper end of the dolly integration module.

The space modules may be used as an expansion space by connecting the space modules to each other in a row or at a right angle by using the connection structure.

According to an embodiment of the disclosure, the completed structure may be standardized and utilized in the various spaces, may be used for the various purposes through the subscription service, and may also be utilized for the visiting service of the bank, the library, the medical care, the shopping, or the like.

In addition, the resources may be utilized efficiently by applying the combination of the reusable driving module and the dolly integration module.

In addition, the parking space may be utilized as a living space by applying the space module that may be used even when the vehicle is stopped unlike the camping car which is used only during camping and is stored separately.

The tire, the suspension, and the driving device may be installed only when necessary, thus improving the initial cost and the flat spot problem of the tire.

The space modules may be assembled to each other and easily moved by the driving device disposed therebelow to enable the automated assembly, thus improving the shortcomings of the conventional mobile home, such as the narrow space and the difficulty in the movement after the installation.

In addition, when applied to the transportation means such as the articulated bus or the bi-modality tram, embodiments of the disclosure may deal with inefficiency occurring when the number of transporters differs based on the time zone in a variable manner by adding the connection module and may improve the problem with the turning radius, the driving ability, the climbing performance, or the like through the steering and driving functions of the dolly integration module.

### BRIEF DESCRIPTION OF THE DRAWINGS

FIG. 1 is a diagram schematically showing a joint structure of a vehicle body according to an embodiment of the disclosure.

FIG. 2 is a diagram schematically showing a space module, which is joined to an underbody, in the joint structure of a vehicle body according to an embodiment of the disclosure.

FIG. 3 is a diagram schematically showing that an additional space module is joined to the space module by using a lateral connection structure in the joint structure of a vehicle body according to an embodiment of the disclosure.

FIG. 4 is a diagram showing a dolly integration module, which is installed at the front part of the underbody, in the joint structure of a vehicle body according to an embodiment of the disclosure.

FIG. 5 is a diagram showing a driving module, which includes an autonomous traveling device and a lighting device, in the joint structure of a vehicle body according to an embodiment of the disclosure.

FIG. 6 is a diagram showing an external airbag, which is installed in the space module, in the joint structure of a vehicle body according to an embodiment of the disclosure.

FIG. 7 is a diagram schematically showing that the additional space module is joined to the space module by using a rear connection structure in the joint structure of a vehicle body according to an embodiment of the disclosure.

FIG. 8 is a diagram showing a process of joining the driving module and a rear wheel suspension device to the stopped space module in the joint structure of a vehicle body according to an embodiment of the disclosure.

FIG. 9 is an enlarged view of portion “A” of FIG. 8, to which the rear wheel suspension device and the front part of the underbody are joined, in the joint structure of a vehicle body according to an embodiment of the disclosure.

FIG. 10 is an enlarged view of portion “B” of FIG. 8, to which the driving module and the front part of the underbody are joined, in the joint structure of a vehicle body according to an embodiment of the disclosure.

FIG. 11 is a diagram showing a process of joining the dolly integration module and the rear wheel suspension device to the space module, in the joint structure of a vehicle body according to an embodiment of the disclosure.

FIG. 12 is an enlarged view of portion “C” of FIG. 11, to which the dolly integration module and the front part of the underbody are joined, in the joint structure of a vehicle body according to an embodiment of the disclosure.

FIG. 13 is a diagram showing a process of controlling a position of the module by detections of a driving module sensor and a space module sensor in the joint structure of a vehicle body according to an embodiment of the disclosure.

FIG. 14 is a diagram showing that a dummy dolly integration module is further disposed between the space module and the additional space module in the joint structure of a vehicle body according to an embodiment of the disclosure.

FIG. 15 is an enlarged view of portion “D” of FIG. 14, to which the dolly integration module, the driving module, and the rear wheel suspension device are joined to one another, in the joint structure of a vehicle body according to an embodiment of the disclosure.

FIG. 16 is a view showing the bottom of FIG. 15.

### DETAILED DESCRIPTION OF ILLUSTRATIVE EMBODIMENTS

Hereinafter, embodiments of the disclosure will be described in detail with reference to the accompanying drawings so that those skilled in the art to which the disclosure pertains may easily practice the disclosure. The disclosure may be implemented in various different forms and is not limited to the embodiments described herein.

In addition, in several embodiments, components having the same configuration will be representatively described using the same reference numerals in an embodiment, and only components different from those of the embodiment will be described in the other embodiments.

It should be understood that the drawings are schematic and not drawn to scale. The size and proportion of a component in the drawings are shown relatively exaggerated or reduced in size in order to clearly and easily explain the drawings. This arbitrary size is only illustrative and not limitative. In addition, the same reference numeral is used to denote a similar feature of the same structure, element, or part shown in two or more drawings. When it is described that an element is referred to as being “on” or “above” another element, it is to be understood that the element may be directly “on” another element or “above” another element having a third element interposed therebetween.

An embodiment of the disclosure specifically represents one embodiment of the disclosure. As a result, diagrams may be variously modified. Accordingly, an embodiment is not limited to a specific shape of the illustrated portion, and may include, for example, a shape modified when produced.

Hereinafter, a joint structure of a vehicle body according to embodiments of the disclosure is described in detail with reference to the accompanying drawings.

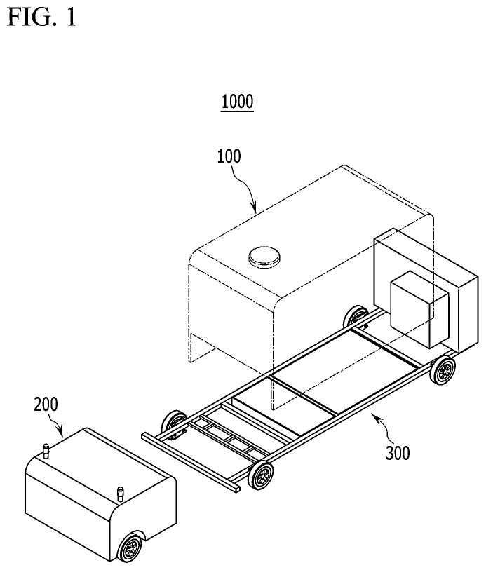

FIG. 1 is a diagram schematically showing a joint structure of a vehicle body according to an embodiment of the disclosure.

Referring to FIG. 1, a joint structure of a vehicle body of a vehicle 1000 according to an embodiment of the disclosure may be applied to, for example, a purpose-based mobility vehicle (or a purpose built vehicle, hereinafter referred to as a “PBV”).

The PBV may be utilized as an electric vehicle-based life module vehicle providing various customized services to a user during a travel time from its origin to destination.

In an embodiment, the PBV may be manufactured in a one box type design with a large interior space. Furthermore, the PBV may also apply facing-type seats to the interior space.

A vehicle body of the PBV may be suitable for small quantity production of various vehicle types having a small number of parts and may be manufactured in various shapes and sizes.

Furthermore, the vehicle body of the PBV may include a skateboard-type underbody 300 (commonly referred to as a “rolling chassis” or a “chassis frame” by those skilled in the art) and upper bodies 100 and 200 assembled to the underbody 300.

The underbody 300 may be mounted with a part such as a battery assembly or a drive motor. In addition, the upper body 100 or 200 may be a body-in-white (BIW) joined to the underbody 300 and may include a spacious cabin or a luggage room.

The joint structure of a vehicle body according to an embodiment of the disclosure may be a structure for applying an upper body of various shapes and purposes to the underbody based on a type of customized service for the PBV.

For this purpose, the joint structure of a vehicle body according to an embodiment of the disclosure may be the upper body and include the driving module 200 and the space module 100.

In an embodiment of the disclosure, the driving module 200 may include a cab-type front cabin. The driving module 200 may be detachable from a front part of the underbody 300.

In an embodiment of the disclosure, the space module 100 may include a rear cabin or a luggage room. The space module may be disposed on a top part of the underbody and may be detachable from the rear of the driving module.

Here, the space module 100 may be detachable from the upper rear part of the underbody 300 in a vertical direction. In addition, the space module 100 may be detachable from the rear part of the driving module 200 in a front-to-back direction of the vehicle body. The space module 100 may be manufactured in various shapes based on a purpose of the PBV.

The space module 100 may be joined to the underbody 300, moved independently, joined to and communicated/cooperated with the driving module 200 to thus be moved in a group, and changed and replaced based on the shape and purpose of the space module 100.

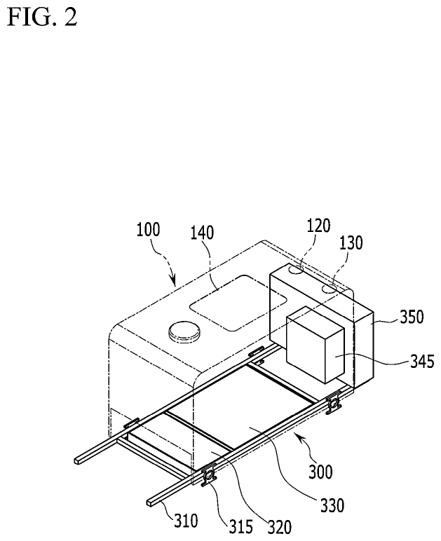

FIG. 2 is a diagram schematically showing the space module, which is joined to the underbody, in the joint structure of a vehicle body according to an embodiment of the disclosure.

Referring to FIG. 2, the underbody 300 may be mounted with at least one detachable battery 320 or 330 storing energy to be consumed by the space module 100. The battery may include the basic battery 320 storing energy to be consumed by the space module, and the swappable battery 330 that may be added when consuming a lot of energy.

In addition, the space module 100 may be mounted with a detachable controller 345 which controls a device installed at the underbody 300, the driving module 200, or the space module 100, and performs calculation for the device. The controller 345 may be a computer device implemented as at least one processor operated based on a set program.

In addition, the space module 100 may be provided with a detachable integrated thermal management device 350 disposed outside the space module 100. The integrated thermal management device 350 may function to perform cooling, heating, and air-conditioning in the space module 100 or to cool an energy storage device or the like in the space module 100.

The space module 100 may be installed with a camera 120 functioning as a closed-circuit television (CCTV) when the vehicle is stopped and functioning as an autonomous traveling device when the vehicle is moving. The camera 120 may be disposed on an upper side of the space module 100.

In addition, the space module 100 may be installed with a space lighting device 130 functioning as an external light or a flashing light.

In addition, the space module 100 may be installed with a solar roof 140 disposed on an outer surface and functioning to convert light energy to electrical energy.

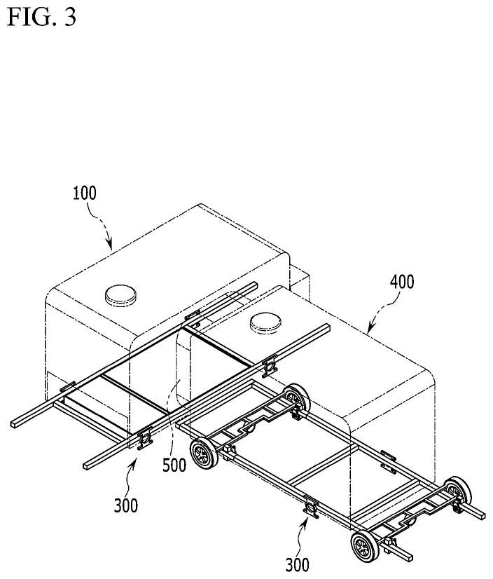

FIG. 3 is a diagram schematically showing that an additional space module is joined to the space module by using a lateral connection structure in the joint structure of a vehicle body according to an embodiment of the disclosure.

As shown in FIG. 3, the space modules 100 of various purposes and shapes may be connected to each other to use the connected space modules 100 as an expansion space.

In the space module 100, an additional space module 400 may be connected to a side part of the space module 100 by using a lateral connection structure 500. The space module 100, the lateral connection structure 500, and the additional space module 400 may be connected to and communicate with one another at a connection portion.

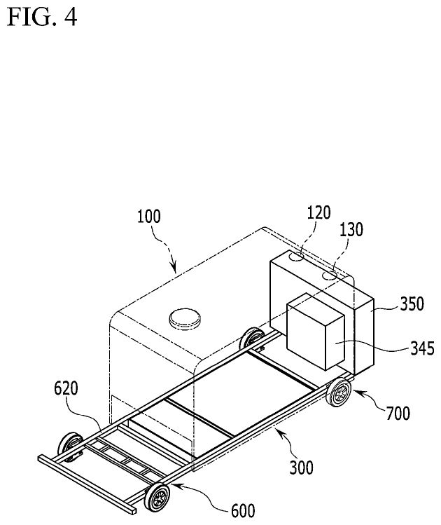

FIG. 4 is a diagram showing a dolly integration module, which is installed at the front part of the underbody, in the joint structure of a vehicle body according to an embodiment of the disclosure.

Referring to FIG. 4, the joint structure of a vehicle body according to an embodiment of the disclosure may further include a dolly integration module 600. The detachable dolly integration module 600 may be disposed at the front part of the underbody 300 and may be driven by an in-wheel motor to move the space module 100 while the space module 100 is mounted on the underbody 300.

The dolly integration module 600 may include a dolly autonomous traveling electronic device 620 enabling low-speed autonomous traveling and driving.

The joint structure may further include a rear wheel suspension device 700 installed at a rear part of the underbody 300 and enabling the space module 100 to be moved smoothly. The rear wheel suspension device 700 may provide a driving force or may be rotated to assist the movement of the space module 100.

As shown in FIG. 4, when moved over a short distance at a low speed, the space module 100 may be moved smoothly by driving the dolly integration module 600 by using the dolly autonomous traveling electronic device 620 and adding the rear wheel suspension device 700 disposed at the rear part of the underbody 300. A tire may be installed when the space module 100 is moved, thus improving a flat spot problem, and the tire may remain installed unless the vehicle is parked for a long time period. Therefore, a position of the space module 100 may be moved or set for sun position, crime prevention, or privacy protection.

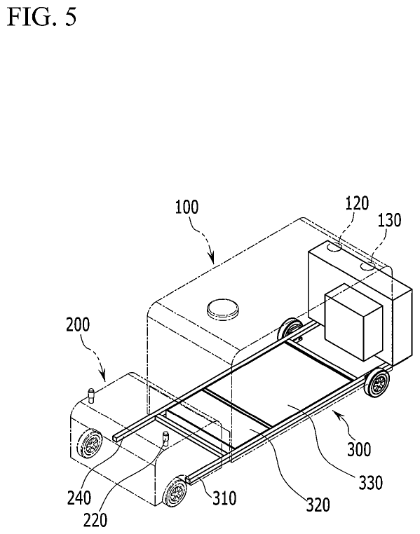

FIG. 5 is a diagram showing the driving module, which includes an autonomous traveling device and a lighting device, in the joint structure of a vehicle body according to an embodiment of the disclosure.

Referring to FIG. 5, the driving module 200 may include a driving autonomous traveling device 220 and a driving lighting device 240 that enable the autonomous traveling and driving of the driving module 200. When the space module 100 is moved over a medium distance at a medium speed, the joint structure may further include a swappable battery 320 to increase a pure electric traveling range (or an all-electric range (AER)).

The structure may include and move the driving module 200 including the driving autonomous traveling device 220 and the driving lighting device 240 to thus independently perform autonomous traveling.

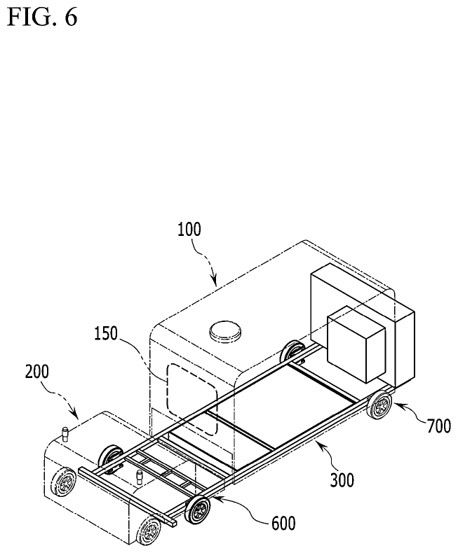

FIG. 6 is a diagram showing an external airbag, which is installed in the space module, in the joint structure of a vehicle body according to an embodiment of the disclosure.

As shown in FIG. 6, the space module 100 may be installed with an external airbag 150 for absorbing an impact occurring when the driving module 200 and the space module 100 collide with each other.

When the space module 100 is moved over a long distance at a high speed, the joint structure may further include the dolly integration module 600 differentiated based on a weight of the structure and installed at the front part of the underbody 300. The vehicle may travel through communication and cooperative control between the dolly integration module 600, the driving module 200, and the space module 100, and the vehicle may add the swappable battery 320 by considering the all-electric range (AER).

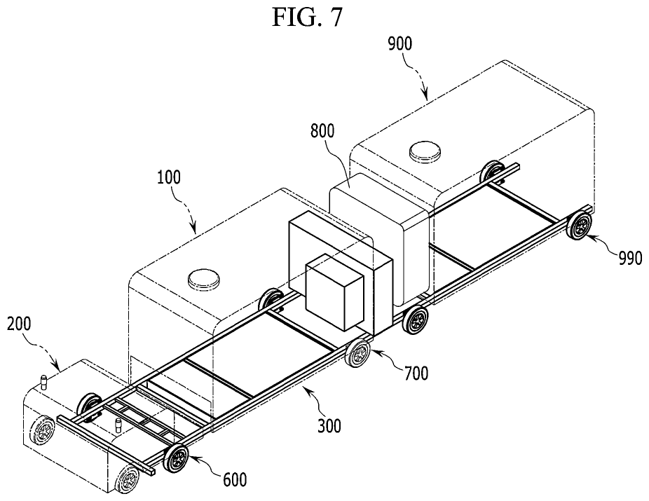

FIG. 7 is a diagram schematically showing that the additional space module is joined to the space module by using a rear connection structure in the joint structure of a vehicle body according to an embodiment of the disclosure.

As shown in FIG. 7, an additional space module 900 may be connected to the rear of the space module 100 by a rear connection structure 800.

The space module 100 may be moved having many people on board or a large space may be needed after the movement. In this case, the space module 100 may be moved by installing the rear connection structure 800 on the dolly integration module 600 and connecting the additional space module 900 thereto. After the space module 100 is moved, the additional space module 900 may be connected to the side of the space module 100 and then be used as shown in FIG. 3.

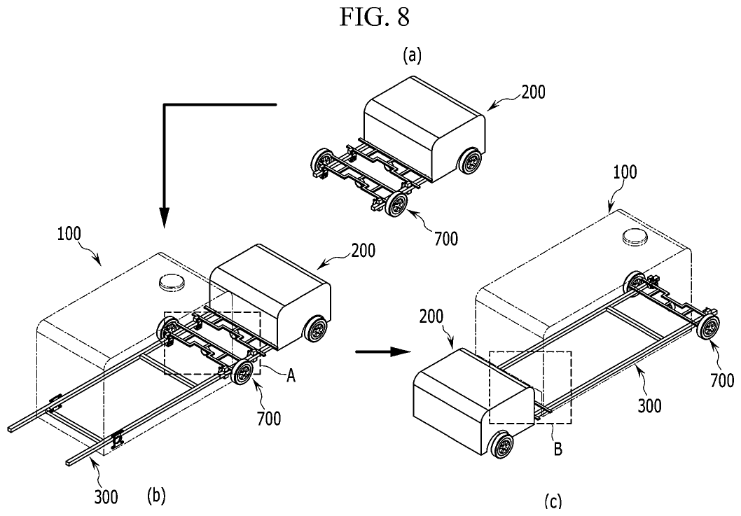

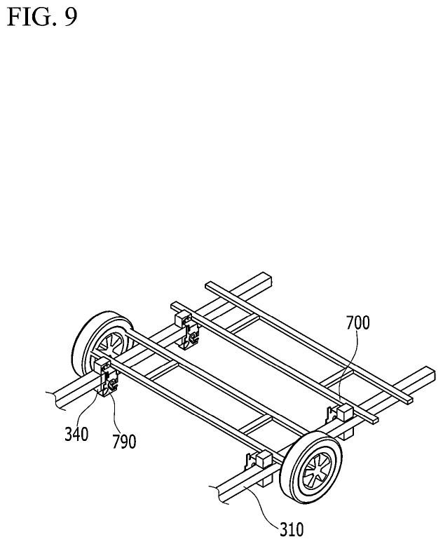

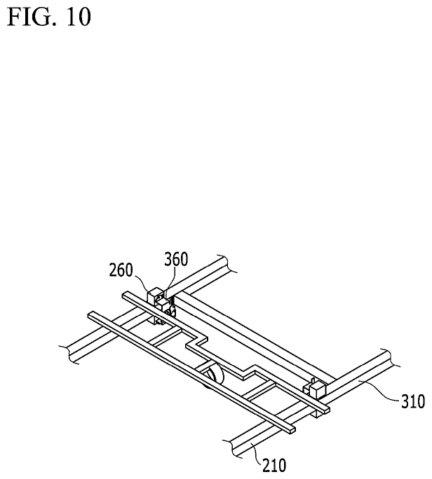

FIG. 8 is a diagram showing a process of joining the driving module and the rear wheel suspension device to the stopped space module in the joint structure of a vehicle body according to an embodiment of the disclosure; FIG. 9 is an enlarged view of portion “A” of FIG. 8, to which the rear wheel suspension device and the front part of the underbody are joined, in the joint structure of a vehicle body according to an embodiment of the disclosure; and FIG. 10 is an enlarged view of portion “B” of FIG. 8, to which the driving module and the front part of the underbody are joined, in the joint structure of a vehicle body according to an embodiment of the disclosure.

Referring to FIGS. 8 to 10, the rear wheel suspension device 700 may be installed with a rear wheel latch 790, and the space module 100 may be installed with a space striker 340. The space striker 340 may be installed on a vehicle body 310 of the space module 100.

The rear wheel suspension device 700 and the driving module 200 may be connected to each other (see position (a) of FIG. 8). In this state, the rear wheel suspension device 700 may be moved backward to the space module 100, the rear wheel latch 790 and the space striker 340 may thus be fastened to each other, and accordingly, the rear wheel suspension device 700 may be joined to the space module 100 (see position (b) of FIG. 8).

The rear wheel suspension device 700 and the space striker 340 may then be released from each other, and the rear wheel suspension device 700 may thus be moved to an opposite side of the space module 100. A space latch 360 and a driving striker 260 of the driving module 200 may then be fastened to each other, and accordingly, the space module 100 and the driving module 200 may be joined to each other (see position (c) of FIG. 8). The driving striker 260 may be installed on a vehicle body 210 of the driving module 200.

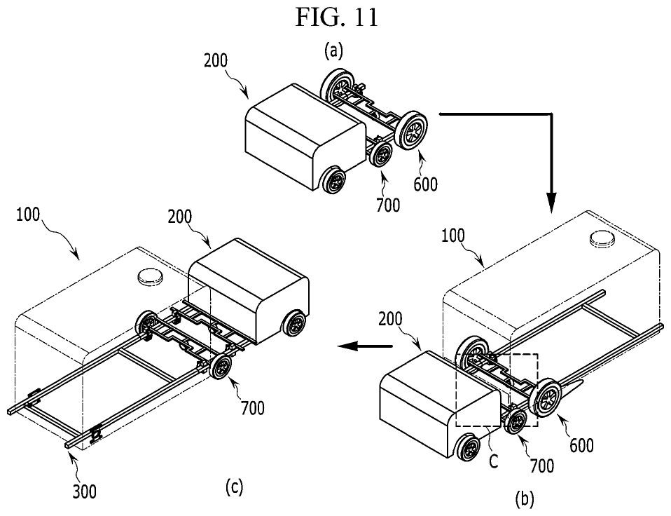

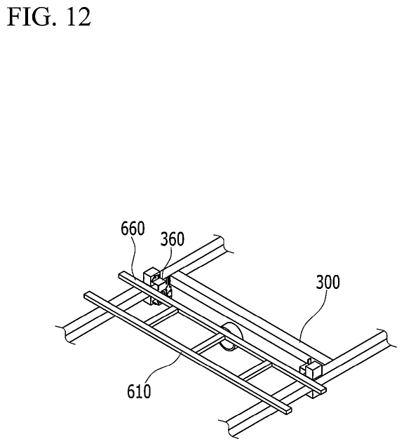

FIG. 11 is a diagram showing a process of joining the dolly integration module and the rear wheel suspension device to the space module in the joint structure of a vehicle body according to an embodiment of the disclosure, and FIG. 12 is an enlarged view of portion “C” of FIG. 11, to which the dolly integration module and the front part of the underbody are joined, in the joint structure of a vehicle body according to an embodiment of the disclosure.

Referring to FIGS. 9, 11, and 12, the dolly integration module 600 may be installed with a dolly integration striker 660, and the space module 100 may be installed with the space latch 360. The dolly integration striker 660 may be installed on a vehicle body 610 of the dolly integration module 600.

The dolly integration striker 660 and the space latch 360 may be joined to each other, and the driving module 200, the rear wheel suspension device 700, and the dolly integration module 600 may thus be connected to one another (see position (a) of FIG. 11). In this state, the rear wheel suspension device 700 may be moved backward to the space module 100, the dolly integration striker 660 may thus be connected to the space latch 360, and accordingly, the rear wheel suspension device 700 may be fastened to the space module 100 (see position (b) of FIG. 11).

A dolly integration latch 680 may be released from a rear wheel striker 270, thus leaving the dolly integration module 600, and the driving module 200 and the rear wheel suspension device 700 may thus be moved to the opposite side of the space module 100. In addition, the rear wheel latch 790 of the rear wheel suspension device 700 and the space striker 340 of the space module 100 may be joined to each other, and accordingly, the driving module 200 and the rear wheel suspension device 700 may be joined to the space module 100 (see position (c) of FIG. 11).

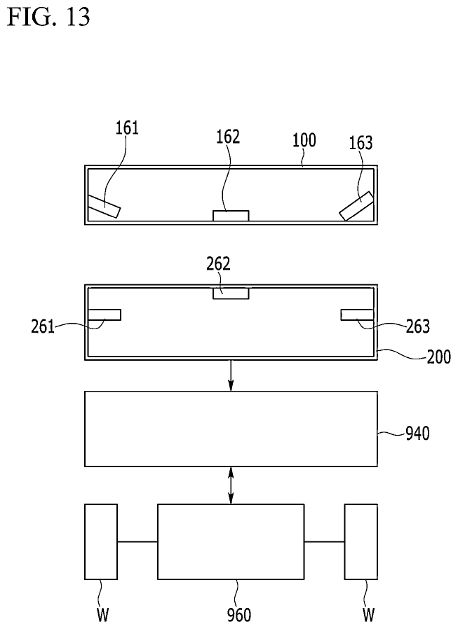

FIG. 13 is a diagram showing a process of controlling a position of the module by detection of a driving module sensor and a space module sensor in the joint structure of a vehicle body according to an embodiment of the disclosure.

Referring to FIG. 13, a driving module sensor 261, 262, or 263 may be disposed at the rear part of the driving module 200, and a space module sensor 161, 162, or 163 may be disposed at a front part of the space module 100. Distance and angle signals between the driving module 200 and the space module 100 may be measured by mutual detection of the driving module sensor 261, 262, or 263 and the space module sensor 161, 162, or 163 to be transmitted to a sensor control unit 940.

The sensor control unit 940 may control a motor 960 and a wheel W, disposed at the driving module 200, by the measured distance and angle signals. The angle, distance, and speed of the driving module 200 may be adjusted by the movement and rotation of the wheel W, and the driving module 200 may be stably fastened to the space module 100.

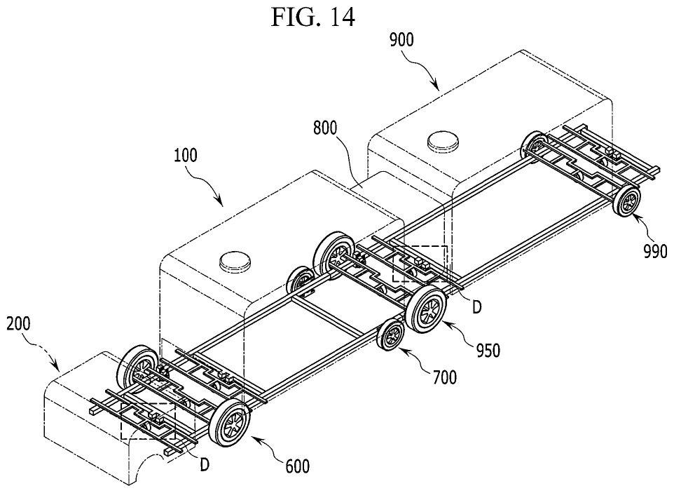

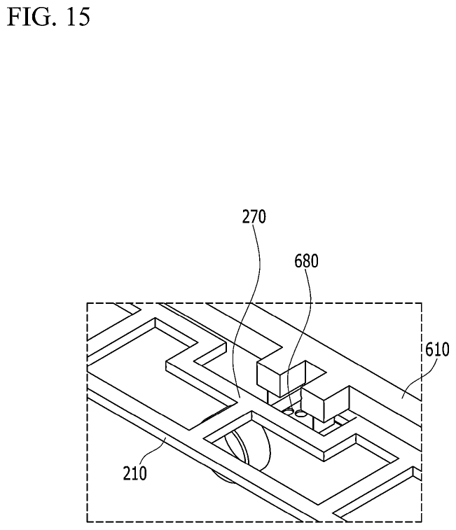

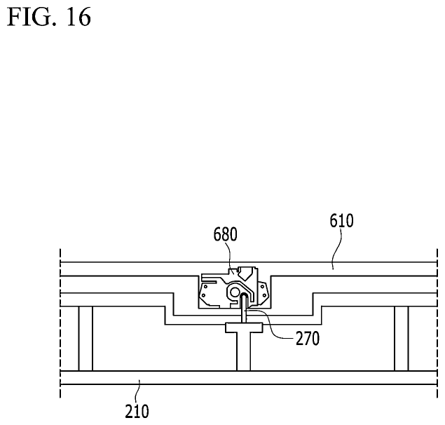

FIG. 14 is a diagram showing that a dummy dolly integration module is further disposed between the space module and the additional space module in the joint structure of a vehicle body according to an embodiment of the disclosure; FIG. 15 is an enlarged view of portion “D” of FIG. 14, to which the dolly integration module, the driving module, and the rear wheel suspension device are joined to one another, in the joint structure of a vehicle body according to an embodiment of the disclosure; and FIG. 16 is a view showing the bottom of FIG. 15.

Referring to FIGS. 14 to 16, the additional space module 900 may be further disposed at a rear end of the space module 100, and the space module 100 and the additional space module 900 may be connected to each other by the rear connection structure 800.

A dummy dolly integration module 950 may be further disposed between the space module 100 and the additional space module 900.

The rear wheel suspension device 700 and the front part of the underbody 300 may be joined to each other by fastening the rear wheel striker 270 and the dolly integration latch 680 to each other. The dolly integration latch 680 may be installed on the vehicle body 610 of the dolly integration module 600. The rear wheel striker 270 may be fastened to the dolly integration latch 680 by its rotation. Therefore, a turning radius may be reduced by giving an angle when the driving module 200 and the space module 100 are joined to each other.

As set forth above, according to an embodiment of the disclosure, the completed structure may be standardized and utilized in the various spaces, may be used for the various purposes through the subscription service, and may also be utilized for the visiting service of the bank, the library, medical care, shopping, or the like.

In addition, the resources may be utilized efficiently by applying the combination of the reusable driving module and the dolly integration module.

In addition, the parking space may be utilized as a living space by applying the space module that may be used even when the vehicle is stopped unlike the camping car which is used only during camping and stored separately.

The tire, the suspension, and the driving device may be installed only when necessary, thus improving the initial cost and the tire flat spot.

The space modules may be assembled to each other and easily moved by the driving device disposed therebelow to enable the automated assembly, thus improving the shortcomings of the conventional mobile home, such as the narrow space and the difficulty in the movement after the installation.

In addition, when applied to the transportation means such as the articulated bus or the bi-modality tram, embodiments of the disclosure may deal with inefficiency occurring when the number of transporters differs based on the time zone in a variable manner by adding the connection module and improve the problem with the turning radius, the driving ability, the climbing performance, or the like through the steering and driving functions of the dolly module.

Although the embodiments of the disclosure have been described hereinabove, the scope of the disclosure is not limited thereto, and all equivalent modifications easily modified by those skilled in the art to which the disclosure pertains are intended to fall within the scope and spirit of the disclosure.

The following reference identifiers may be used in connection with the drawings to describe various features of embodiments of the disclosure.

| | |
|---|---|
| 1000: vehicle | 100: space module |
| 120: camera | 130: space lighting device |
| 140: solar roof | 150: external airbag |
| 161, 162, or 163: space module sensor | 200: driving module |
| 220: driving autonomous traveling device | 240: driving lighting device |
| 260: driving striker | 261, 262, or 263: driving module |
| 270: rear wheel striker | 300: underbody |
| 320: basic battery | 330: swappable battery |
| 340: space striker | 345: controller |
| 350: integrated thermal management device | 360: space latch |
| 400 or 900: additional space module | 500: lateral connection structure |
| 600: dolly integration module | 680: dolly integration latch |
| 620: dolly autonomous traveling electronic device | 790: rear wheel latch |
| 660: dolly integration striker | 940: sensor control unit |
| 700 or 990: rear wheel suspension system | 960: motor |
| 800: rear connection structure | |
| 950: additional dolly integration module | |
| W: wheel | |

What is claimed is:

1. A joint structure of a vehicle body, the joint structure comprising:
a driving module detachably mountable on a front part of an underbody of a vehicle; and
a space module detachably mountable on the underbody, wherein the space module is selected from a plurality of differently shaped space modules, is joinable to the underbody, is capable of being moved independently, is joinable to the driving module to be movable in a group with the driving module, and is interchangable with other space modules of the plurality of differently shaped space modules selectable based on a shape and a purpose of the space module.

2. The joint structure of claim 1, further comprising a detachable battery mounted on the underbody, the detachable battery being configured to store energy consumable by the space module.

3. The joint structure of claim 1, further comprising a detachable controller mounted on the space module, the detachable controller being configured to control a device installed at the underbody, the driving module, or the space module and to perform a calculation for the device.

4. The joint structure of claim 1, further comprising a detachable integrated thermal management device disposed outside the space module, the detachable integrated thermal management device being configured to perform cooling, heating, and air-conditioning in the space module or to perform cooling of a device in the space module.

5. The joint structure of claim 1, further comprising:
a camera mounted on the space module, the space module being configured to function as a closed-circuit television (CCTV) and an autonomous traveling device;
a space lighting device configured to function as an external light and a flashing light; and
a solar roof configured to function to convert light energy to electrical energy.

6. The joint structure of claim 1, wherein the driving module comprises a driving autonomous traveling device and a driving lighting device configured to enable autonomous traveling and driving of the driving module.

7. The joint structure of claim 1, further comprising an external airbag disposed on the space module, the external airbag being configured to absorb an impact in a case in which the driving module and the space module collide with each other.

8. The joint structure of claim 1, further comprising an additional space module connected to a side part of the space module by a lateral connection structure.

9. The joint structure of claim 1, further comprising:
a driving module sensor disposed at a rear part of the driving module; and
a space module sensor disposed at a front part of the space module.

10. The joint structure of claim 9, wherein distance and angle signals between the driving module and the space module are measured by mutual detection of the driving module sensor and the space module sensor to be transmitted to a sensor controller.

11. The joint structure of claim 10, wherein the sensor controller is configured to control a motor and a wheel, disposed at the driving module, according to the measured distance and angle signals.

12. A joint structure of a vehicle body, the joint structure comprising:
a driving module detachably mountable on a front part of an underbody of a vehicle;
a space module detachably mountable on the underbody, wherein the space module is selected from a plurality of differently shaped space modules, is joinable to the underbody, is capable of being moved independently, is joinable to the driving module to be movable in a group with the driving module, and is interchangable with other space modules of the plurality of differently shaped space modules selectable based on a shape and a purpose of the space module; and
a detachable dolly integration module disposed at the front part of the underbody and configured to be driven by an in-wheel motor to move the space module in a state in which the space module is mounted on the underbody.

13. The joint structure of claim 12, wherein the detachable dolly integration module comprises a dolly autonomous traveling electronic device configured to enable low-speed autonomous traveling and driving.

14. The joint structure of claim 12, further comprising a rear wheel suspension device disposed at a rear part of the underbody or the rear of the driving module, the rear wheel suspension device being configured to enable the space module to be moved.

15. The joint structure of claim 14, wherein the rear wheel suspension device and the detachable dolly integration module are sequentially joined to the rear of the driving module.

16. The joint structure of claim 14, further comprising an additional space module disposed at a rear end of the space module, wherein the additional space module is installed with an additional dolly integration module and the rear wheel suspension device, and wherein the space module is moved by installing a rear connection structure between the space module and the additional space module and on an upper end of the detachable dolly integration module.

17. The joint structure of claim 16, wherein the space module and the additional space module are configured to be used as an expansion space by connecting the space module and the additional space module to each other in a row or at a right angle using the rear connection structure.

18. The joint structure of claim 12, further comprising a detachable battery mounted on the underbody, the detachable battery being configured to store energy consumable by the space module.

19. The joint structure of claim 12, further comprising a detachable controller mounted on the space module, the detachable controller being configured to control a device installed at the underbody, the driving module, or the space module and to perform a calculation for the device.

20. The joint structure of claim 12, further comprising a detachable integrated thermal management device disposed outside the space module, the detachable integrated thermal management device being configured to perform cooling, heating, and air-conditioning in the space module or to perform cooling of a device in the space module.
